(19) United States
(12) Patent Application Publication
(10) Pub. No.: US 2026/0049869 A1
(43) Pub. Date: Feb. 19, 2026

(54) DETECTION SYSTEM AND DETECTION METHOD

(71) Applicant: REALTEK SEMICONDUCTOR CORPORATION, Hsinchu (TW)

(72) Inventors: PAO-CHI YEH, Hsinchu (TW); Tsung-Chi LEE, Hsinchu (TW); Shi-Hao LI, Hsinchu (TW); Chao-Hsun YANG, Hsinchu (TW); Jung-Li WONG, Hsinchu (TW)

(21) Appl. No.: 19/302,258

(22) Filed: Aug. 18, 2025

(30) Foreign Application Priority Data
Aug. 19, 2024 (TW) 113131172

(51) Int. Cl. G01J 5/00; G01J 5/02; G01J 5/03; G08B 21/22

(52) U.S. Cl. CPC G01J 5/0025; G01J 5/026; G01J 5/03; G08B 21/22

(57) ABSTRACT

A detection system includes a visible light detector, an infrared detector, and a processing circuit. The visible light detector is configured to detect visible light. The infrared detector is configured to detect infrared light. The processing circuit is configured to determine whether a parameter of the visible light detector is larger than a threshold. If the parameter of the visible light detector is larger than the threshold, the processing circuit executes a human presence detection according to the infrared light detected by the infrared detector, and generates a human presence detection result.

### BACKGROUND OF THE INVENTION

### 1. Field of the Invention

The present disclosure relates to a detection system and a detection method, especially to a detection system and a detection method that adaptively utilize a visible light detector or an infrared detector for executing a human presence detection according to parameters.

### 2. Description of Related Art

Conventional human presence detection devices (HPD) equipped in notebooks are usually visible light detection devices. These visible light detection devices can detect human presence through image processing. However, in low-light conditions, the sensitivity of the visible light detection devices decreases, and it is difficult for the visible light detection devices to detect human presence.

### SUMMARY OF THE INVENTION

In some aspects, an object of the present disclosure is to, but not limited to, provides a detection system and a detection method that make an improvement to the prior art.

An embodiment of a detection system of the present disclosure includes a visible light detector, an infrared light detector, and a processing circuit. The visible light detector is configured to detect visible light. The infrared light detector is configured to detect infrared light. The processing circuit is configured to determine whether a parameter of the visible light detector is larger than a threshold. If the parameter of the visible light detector is larger than the threshold, the processing circuit executes a human presence detection according to the infrared light detected by the infrared light detector, and generates a human presence detection result.

An embodiment of a detection method of the present disclosure is applied in a detection system. The detection system includes a visible light detector, an infrared light detector, and a processing circuit. The detection method includes following steps: determining whether a parameter of the visible light detector is larger than a threshold by the processing circuit; if the parameter of the visible light detector is larger than the threshold, executing a human presence detection by the processing circuit according to infrared light detected by the infrared light detector; and generating a human presence detection result by the processing circuit.

Technical features of some embodiments of the present disclosure make an improvement to the prior art. The detection system and the detection method of the present disclosure can adaptively utilize the visible light detector or the infrared light detector according to parameters of the visible light detector. As a result, in well-lit conditions, the present disclosure can utilize the visible light detector for executing a human presence detection. Additionally, in low-light conditions, the present disclosure can utilize the infrared light detector for executing the human presence detection to avoid the problem that it is difficult for the visible light detector to detect the human presence under low-light conditions.

These and other objectives of the present invention will no doubt become obvious to those of ordinary skill in the art after reading the following detailed description of the preferred embodiments that are illustrated in the various figures and drawings.

### BRIEF DESCRIPTION OF THE DRAWINGS

FIG. 1 shows an embodiment of a detection system of the present disclosure.

FIG. 2 shows an embodiment of a flow diagram of a detection method of the present disclosure.

FIG. 3 shows an embodiment of operations of a detection system of the present disclosure.

FIG. 4 shows an embodiment of a flow diagram of a detection method of the present disclosure.

### DETAILED DESCRIPTION OF THE PREFERRED EMBODIMENTS

To address the problem in the prior art that it is difficult for visible light detectors to detect human presence due to the decreased sensitivity of the visible light detectors under low-light conditions, the present disclosure provides a detection system and a detection method, which will be explained in detail as shown below.

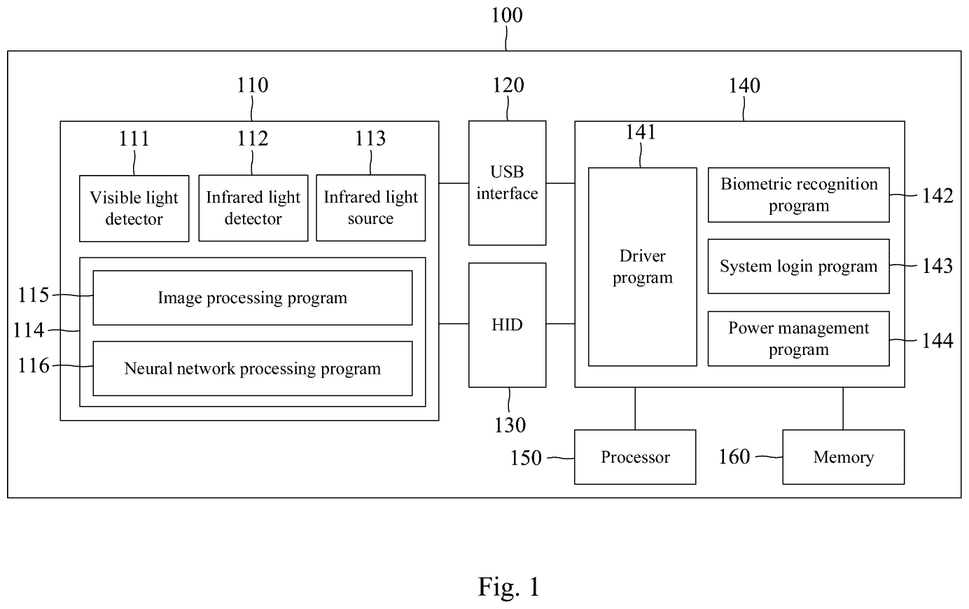

FIG. 1 shows an embodiment of a computer system 100 of the present disclosure. As shown in the figure, the computer system 100 includes a detection system 110, a Universal Serial Bus (USB) interface 120, a Human Interface Device (HID) 130, an operating system 140, a processor 150, and a memory 160.

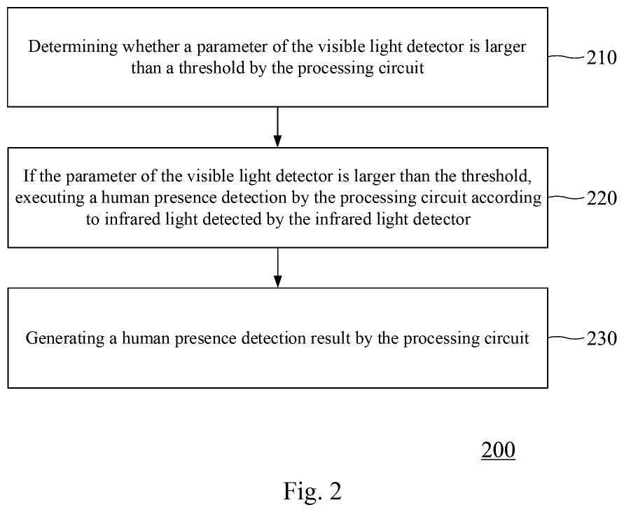

In addition, the detection system 110 includes a visible light detector 111, an infrared light detector 112, an infrared light source 113, and a processing circuit 114. The processing circuit 114 includes an image processing program 115 and a neural network processing program 116. Furthermore, the operating system 140 includes a driver program 141, a biometric recognition program 142, a system login program 143, and a power management program 144. For facilitating the understanding of operations of the detection system 110, reference is made to FIG. 2. FIG. 2 shows an embodiment of a flow diagram of a detection method 200 of the present disclosure.

In step 210, determining whether a parameter of the visible light detector is larger than a threshold by the processing circuit. In step 220, if the parameter of the visible light detector is larger than the threshold, executing a human presence detection by the processing circuit according to infrared light detected by the infrared light detector. In step 230, generating a human presence detection result by the processing circuit.

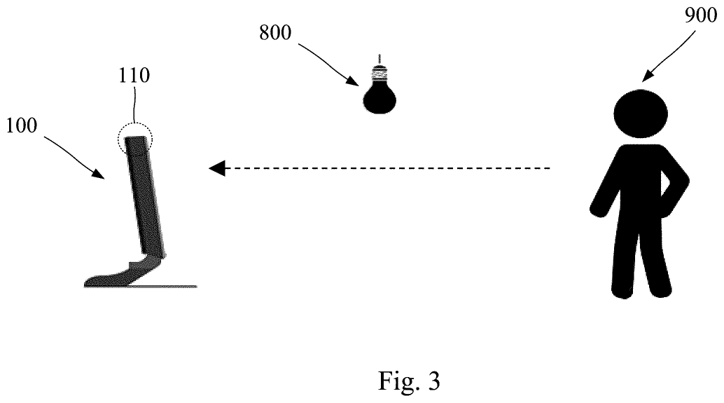

For example, reference is made to both FIG. 1 and FIG. 3. The light source 800 emits visible light, and the visible light detector 111 of the detection system 110 executes an image detection on the human body 900. Subsequently, the processing circuit 114 determines whether a parameter of the visible light detector 111 of the detection system 110 is larger than a threshold. If the parameter of the visible light detector 111 of the detection system 110 is larger than the threshold, it represents that the visible light emitted by the light source 800 is weak, which will lead to a decrease in the sensitivity of the visible light detector 111, making it difficult to detect the human body 900. In this situation, the detection system 110 of the present disclosure switches to utilize the infrared light detector 112 to execute the image detection on the human body 900. The processing circuit 114 executes a human presence detection according to the infrared light detected by the infrared light detector 112, and generates a human presence detection result, thereby avoiding the problem that it is difficult for the visible light detector 111 to detect human presence under low-light conditions

In some embodiments, the parameter can be an exposure value of the visible light detector 111, and the threshold can be an exposure threshold. The processing circuit 114 can determine whether the exposure value of the visible light detector 111 is larger than the exposure threshold. If the exposure value is larger than the exposure threshold, the processing circuit 114 executes a human presence detection according to the infrared light detected by the infrared light detector 112, and generates a human presence detection result.

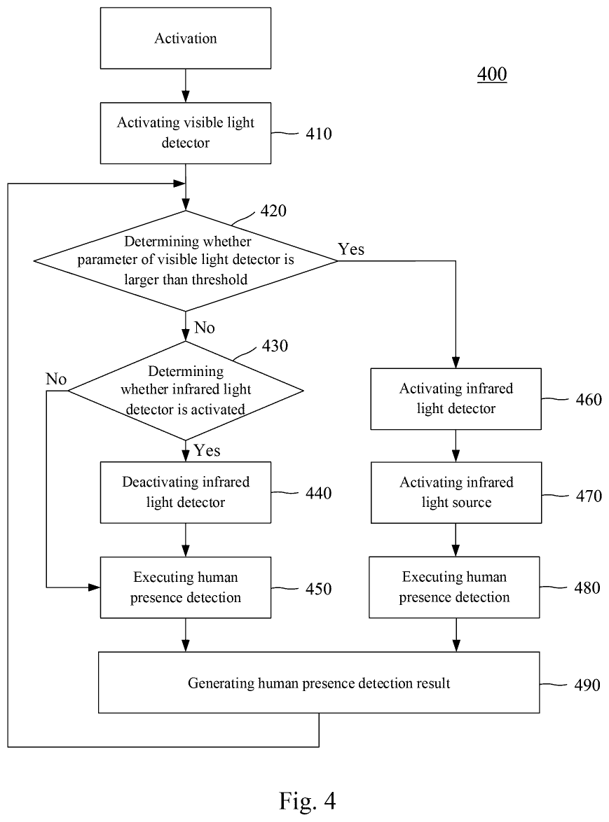

For example, reference is now made to FIG. 3 and FIG. 4. As shown in step 410, after activation, the detection system 110 activates the visible light detector 111. If the visible light emitted by the light source 800 is weak, the exposure time required for the image detection by the visible light detector 111 is longer. The exposure value of the visible light detector 111 is therefore high. The detection system 110 of the present disclosure can determine whether the human body 900 is in a low-light condition according to the exposure value of the visible light detector 111. Accordingly, the detection system 110 of the present disclosure can preset an exposure threshold for the low-light condition. In step 420, the processing circuit 114 of the detection system 110 of the present disclosure can determine whether the parameter (i.e., the exposure value) of the visible light detector 111 is larger than the threshold (i.e., the exposure threshold). When the parameter (i.e., the exposure value) of the visible light detector 111 is larger than the threshold (i.e., the exposure threshold), it represents that the human body 900 is in a low-light condition. In this situation, steps 460 and 470 are executed, the detection system 110 of the present disclosure activates the infrared light detector 112 and the infrared light source 113. In step 480, the detection system 110 of the present disclosure switches to utilize the infrared light detector 112 to execute the image detection on the human body 900. The processing circuit 114 executes the human presence detection according to the infrared light detected by the infrared light detector 112. In step 490, the processor 150 generates the human presence detection result.

In some embodiments, when the human body 900 is in a low-light condition, to increase the brightness of the image captured by the visible light detector 111, the visible light detector 111 reduces the frames per second (FPS) to increase the exposure time. The frames per second (FPS) can be set to 1, and the exposure time can be 1000 milliseconds(ms). Accordingly, the detection system 110 of the present disclosure can preset the exposure threshold for low-light conditions to 1000 milliseconds(ms). Once the exposure value of the visible light detector 111 is larger than the exposure threshold, the detection system 110 of the present disclosure switches to utilize the infrared light detector 112 to execute the image detection on the human body 900.

In some embodiments, the parameter can also be a detection value of the visible light detector 111. The detection value relates to the exposure value and the gain value of the visible light detector 111, and the threshold can be a detection threshold. The processor 150 can determine whether the detection value of the visible light detector 111 is larger than the detection threshold. If the detection value is larger than the detection threshold, the processor 150 executes the human presence detection according to the infrared light detected by the infrared light detector 112, and generates a human presence detection result.

For example, reference is made to FIG. 3 and FIG. 4. Suppose the visible light emitted by the light source 800 in FIG. 3 is weak. In this situation, the exposure time required for the image detection by the visible light detector 111 is longer, and the gain is high. Therefore, the combined detection value calculated from the exposure value and the gain value of the visible light detector 111 is high. The detection system 110 of the present disclosure can determine whether the human body 900 is in a low-light condition according to the detection value of the visible light detector 111. Accordingly, the detection system 110 of the present disclosure can preset a detection threshold for low-light conditions. In step 420, the processing circuit 114 of the detection system 110 of the present disclosure can determine whether the parameter (i.e., the detection value) of the visible light detector 111 is larger than the threshold (i.e., the detection threshold). When the parameter (i.e., the detection value) of the visible light detector 111 is larger than the threshold (i.e., the detection threshold), it represents that the human body 900 is in a low-light condition. In this situation, steps 460 and 470 are executed, the detection system 110 of the present disclosure activates the infrared light detector 112 and the infrared light source 113. In step 480, the detection system 110 of the present disclosure switches to utilize the infrared light detector 112 to execute the image detection on the human body 900. The processing circuit 114 executes a human presence detection according to the infrared light detected by the infrared light detector 112. In step 490, the processing circuit 114 generates a human presence detection result.

In some embodiments, when the human body 900 is in a low-light condition, the frames per second (FPS) of the visible light detector 111 can be set to 1, the exposure time of the visible light detector 111 can be 1000 milliseconds(ms), and the gain of the visible light detector 111 can be 15 times. The detection threshold can be set as the product of the exposure time and the gain, which is 15000. Accordingly, the detection system 110 of the present disclosure can preset the detection threshold for low-light conditions to 15000. Once the combined detection value calculated from the exposure value and the gain value of the visible light detector 111 is larger than the detection threshold, the detection system 110 of the present disclosure switches to utilize the infrared light detector 112 to execute the image detection on the human body 900. In contrast, when the human body 900 is in a well-lit condition, the frames per second (FPS) of the visible light detector 111 can be set to 3, the exposure time of the visible light detector 111 can be approximately 333.3 milliseconds(ms), and the gain of the visible light detector 111 can be 1 time.

In some embodiments, the visible light detector 111 remains activated. For example, referring to step 410 in FIG. 4, after activation, the detection system 110 of the present disclosure activates the visible light detector 111. Furthermore, for the detection system 110 to enable detection functions in the background, the visible light detector 111 needs to remain continuously activated.

In some embodiments, the infrared light source 113 is configured to emit infrared light, and a frequency of emitting the infrared light by the infrared light source 113 includes once per second. For example, when the detection system 110 of the present disclosure switches to utilize the infrared light detector 112 to execute the image detection on the human body 900, the infrared light source 113 illuminates the human body 900 with the infrared light, and the infrared light detector 112 executes the image detection on the human body 900. It should be noted that since the infrared light source 113 consumes a relatively high current (approximately several hundred milliamperes), the frequency of emitting the infrared light by the infrared light source 113 is set to once per second (one frame per second) to reduce power consumption.

In some embodiments, if the parameter of the visible light detector 111 is not larger than the threshold, the processor 150 determines whether the infrared light detector 112 is activated. If the processor 150 determines that the infrared light detector 112 is activated, the processor 150 deactivates the infrared light detector 112.

For example, reference is made to FIG. 1 and FIG. 3. Suppose the visible light emitted by the light source 800 is sufficient. In this situation, the exposure time required for the image detection by the visible light detector 111 is short, and the exposure value of the visible light detector 111 is therefore low. The detection system 110 of the present disclosure can determine whether the human body 900 is in a well-lit condition according to the exposure value of the visible light detector 111. In step 420 of FIG. 4, the detection system 110 of the present disclosure can determine whether the parameter (i.e., the exposure value) of the visible light detector 111 is larger than the threshold (i.e., the exposure threshold). When the parameter (i.e., the exposure value) of the visible light detector 111 is not larger than the threshold (i.e., the exposure threshold), it represents that the visible light emitted by the light source 800 is sufficient. In this situation, the detection system 110 of the present disclosure can use the visible light detector 111 to execute the image detection on the human body 900 without the need to use the infrared light detector 112. In this situation, step 430 is executed. The processing circuit 114 of the detection system 110 of the present disclosure can determine whether the infrared light detector 112 is activated. If the processing circuit 114 determines that the infrared light detector 112 is activated, step 440 is executed. The processing circuit 114 deactivates the infrared light detector 112 to avoid wasting power. Furthermore, if the processing circuit 114 determines that the infrared light detector 112 is not activated, step 450 is directly executed. The detection system 110 of the present disclosure uses the visible light detector 111 to execute the image detection on the human body 900. The processing circuit 114 executes a human presence detection according to the visible light detected by the visible light detector 111.

In some embodiments, the parameter can be the exposure value of the visible light detector 111, and the threshold can be the exposure threshold. The processing circuit 114 can determine whether the exposure value of the visible light detector 111 is larger than the exposure threshold. If the exposure value is not larger than the exposure threshold, the processing circuit 114 executes the human presence detection according to the visible light detected by the visible light detector 111, and generates a human presence detection result.

For example, reference is made to FIG. 3 and FIG. 4. Suppose the visible light emitted by the light source 800 is sufficient. In this situation, the exposure time required for the image detection by the visible light detector 111 is short, and the exposure value of the visible light detector 111 is therefore low. The detection system 110 of the present disclosure can determine whether the human body 900 is in a well-lit condition according to the exposure value of the visible light detector 111. In step 420, the processing circuit 114 of the detection system 110 of the present disclosure can determine whether the parameter (i.e., the exposure value) of the visible light detector 111 is larger than the threshold (i.e., the exposure threshold). When the parameter (i.e., the exposure value) of the visible light detector 111 is not larger than the threshold (i.e., the exposure threshold), it represents that the human body 900 is in a well-lit condition. In this situation, step 430 is executed to determine whether the infrared light detector 112 needs to be deactivated. Subsequently, step 450 is executed, and the detection system 110 of the present disclosure uses the visible light detector 111 to execute the image detection on the human body 900. The processing circuit 114 executes the human presence detection according to the visible light detected by the visible light detector 111. In step 490, the processing circuit 114 generates a human presence detection result.

In some embodiments, the parameter can be a detection value of the visible light detector 111. The detection value relates to the exposure value and the gain value of the visible light detector 111, and the threshold can be a detection threshold. The processing circuit 114 can determine whether the detection value of the visible light detector 111 is larger than the detection threshold. If the detection value is not larger than the detection threshold, the processing circuit 114 executes the human presence detection according to the visible light detected by the visible light detector 111, and generates a human presence detection result.

For example, reference is now made to FIG. 3 and FIG. 4. Suppose the visible light emitted by light source 800 is sufficient. In this situation, the exposure time required for the image detection by the visible light detector 111 is short, and the gain of the visible light detector 111 is low. Therefore, the combined detection value related to the exposure value and the gain value of the visible light detector 111 is low. The detection system 110 of the present disclosure can determine whether the human body 900 is in a well-lit state according to the detection value of the visible light detector 111. In step 420, the processing circuit 114 of the detection system 110 of the present disclosure can determine whether the parameter (i.e., the detection value) of the visible light detector 111 is larger than the threshold (i.e., the detection threshold). If the parameter (i.e., the detection value) of the visible light detector 111 is not larger than the threshold (i.e., the detection threshold), it represents that the human body 900 is in a well-lit state. In this situation, step 430 is executed to determine whether the infrared light detector 112 needs to be deactivated. Subsequently, in step 450, the detection system 110 of the present disclosure uses the visible light detector 111 to execute the image detection on the human body 900. The processing circuit 114 executes the human presence detection according to the visible light detected by the visible light detector 111. In step 490, the processing circuit 114 generates a human presence detection result.

In some embodiments, the processing circuit 114 logs in the operating system 140 of the computer system 100 according to the human presence detection result. For example, the processing circuit 114 can execute the human presence detection on the human body 900 with visible light or infrared light. If the processing circuit 114 determines that the human body 900 is a real human presence, the processing circuit 114 can log in the operating system 140 of the computer system 100.

Referring to FIG. 1, the human presence detection process is described as shown below. The visible light detector 111 or the infrared light detector 112 detects the human body 900 and transmits the image to the image processing program 115. The image processing program 115 processes the image and sends the processed image to the neural network processing program 116. After the neural network processing program 116 executes the neural network processing on the image, the image processing result is sent to the driver program 141 via the HID 130. The driver program 141 distributes the image processing result to the biometric recognition program 142. The biometric recognition program 142 recognizes the identity of the human body 900 according to the image processing result. Subsequently, the biometric recognition program 142 transmits the identity of the human body 900 to the system login program 143 to log in the operating system of the detection system 110. On the other hand, the driver program 141 can also distribute the image processing result to the power management program 144. The power management program 144 activates a display (not shown in the figure), allowing the display to wake up when the human body 900 approaches the detection system 110.

In some embodiments, the computer system 100 can be a computer, for example, a desktop computer, a laptop, a tablet, or other electronic device. The operating system 140 of the computer system 100 can be a Windows system developed by Microsoft, and the Windows system can include the Windows Hello feature. It should be noted that if the computer has the Windows Hello feature, the computer must include both a visible light detector and an infrared light detector. Therefore, if the technology of the present disclosure is applied to a computer with the Windows Hello feature, there is no need to additionally install an infrared light detector on the computer.

It should be noted that the present disclosure is not limited to the embodiments as shown in FIG. 1 to FIG. 4, they are merely examples for illustrating the implements of the present disclosure, and the scope of the present disclosure shall be defined based on the claims as shown below. In view of the foregoing, it is intended that the present disclosure covers modifications and variations to the embodiments of the present disclosure, and modifications and variations to the embodiments of the present disclosure also fall within the scope of the following claims and their equivalents.

As described above, technical features of some embodiments of the present disclosure make an improvement to the prior art. The detection system 110 and the detection method 200 of the present disclosure can adaptively utilize the visible light detector 111 or the infrared light detector 112 according to parameters of the visible light detector 111. As a result, in well-lit conditions, the present disclosure can utilize the visible light detector 111 for executing a human presence detection. Additionally, in low-light conditions, the present disclosure can utilize the infrared light detector 112 for executing the human presence detection to avoid the problem that it is difficult for the visible light detector 111 to detect the human presence under low-light conditions.

It should be noted that people having ordinary skill in the art can selectively use some or all of the features of any embodiment in this specification or selectively use some or all of the features of multiple embodiments in this specification to implement the present invention as long as such implementation is practicable; in other words, the way to implement the present invention can be flexible based on the present disclosure.

The descriptions represent merely the preferred embodiments of the present invention, without any intention to limit the scope of the present invention thereto. Various equivalent changes, alterations, or modifications based on the claims of the present invention are all consequently viewed as being embraced by the scope of the present invention.

What is claimed is:

1. A detection system, comprising:
a visible light detector, configured to detect visible light;
an infrared light detector, configured to detect infrared light; and
a processing circuit, configured to determine whether a parameter of the visible light detector is larger than a threshold, wherein if the parameter of the visible light detector is larger than the threshold, the processing circuit executes a human presence detection according to the infrared light detected by the infrared light detector, and generates a human presence detection result.

2. The detection system of claim 1, wherein the parameter comprises an exposure value of the visible light detector, and the threshold comprises an exposure threshold, wherein the processing circuit determines whether the exposure value of the visible light detector is larger than the exposure threshold, wherein if the exposure value is larger than the exposure threshold, the processing circuit executes the human presence detection according to the infrared light detected by the infrared light detector, and generates the human presence detection result.

3. The detection system of claim 1, wherein the parameter comprises a detection value of the visible light detector, the detection value relates to an exposure value and a gain value of the visible light detector, and the threshold comprises a detection threshold, wherein the processing circuit determines whether the detection value of the visible light detector is larger than the detection threshold, wherein if the detection value is larger than the detection threshold, the processing circuit executes the human presence detection according to the infrared light detected by the infrared light detector, and generates the human presence detection result.

4. The detection system of claim 1, wherein if the parameter of the visible light detector is larger than the threshold, the processing circuit activates the infrared light detector.

5. The detection system of claim 1, wherein the visible light detector remains activated.

6. The detection system of claim 1, further comprising:
an infrared light source, configured to emit the infrared light, wherein a frequency of emitting the infrared light by the infrared light source comprises once per second.

7. The detection system of claim 1, wherein if the parameter of the visible light detector is not larger than the threshold, the processing circuit is configured to determine whether the infrared light detector is activated, wherein if the processing circuit determines that the infrared light detector is activated, the processing circuit deactivates the infrared light detector.

8. The detection system of claim 1, wherein the parameter comprises an exposure value of the visible light detector, and the threshold comprises an exposure threshold, wherein the processing circuit determines whether the exposure value of the visible light detector is larger than the exposure threshold, wherein if the exposure value is not larger than the exposure threshold, the processing circuit executes the human presence detection according to the visible light detected by the visible light detector, and generates the human presence detection result.

9. The detection system of claim 1, wherein the parameter comprises a detection value of the visible light detector, the detection value relates to an exposure value and a gain value of the visible light detector, and the threshold comprises a detection threshold, wherein the processing circuit determines whether the detection value of the visible light detector is larger than the detection threshold, wherein if the detection value is not larger than the detection threshold, the processing circuit executes the human presence detection according to the visible light detected by the visible light detector, and generates the human presence detection result.

10. The detection system of claim 1, wherein the processing circuit logs in an operating system of a computer system according to the human presence detection result.

11. A detection method, applied in a detection system, wherein the detection system comprises a visible light detector, an infrared light detector, and a processing circuit, wherein the detection method comprises:
determining whether a parameter of the visible light detector is larger than a threshold by the processing circuit;
if the parameter of the visible light detector is larger than the threshold, executing a human presence detection by the processing circuit according to infrared light detected by the infrared light detector; and
generating a human presence detection result by the processing circuit.

12. The detection method of claim 11, wherein the parameter comprises an exposure value of the visible light detector, and the threshold comprises an exposure threshold, wherein determining whether the parameter of the visible light detector is larger than the threshold by the processing circuit comprises:
determining whether the exposure value of the visible light detector is larger than the exposure threshold by the processing circuit;
wherein if the parameter of the visible light detector is larger than the threshold, executing the human presence detection by the processing circuit according to the infrared light detected by the infrared light detector comprises:
if the exposure value is larger than the exposure threshold, executing the human presence detection by the processing circuit according to the infrared light detected by the infrared light detector.

13. The detection method of claim 11, wherein the parameter comprises a detection value of the visible light detector, the detection value relates to an exposure value and a gain value of the visible light detector, and the threshold comprises a detection threshold, wherein determining whether the parameter of the visible light detector is larger than the threshold by the processing circuit comprises:
determining whether the detection value of the visible light detector is larger than the detection threshold by the processing circuit;
wherein if the parameter of the visible light detector is larger than the threshold, executing the human presence detection by the processing circuit according to the infrared light detected by the infrared light detector comprises:
if the detection value is larger than the detection threshold, executing the human presence detection by the processing circuit according to the infrared light detected by the infrared light detector.

14. The detection method of claim 11, further comprising:
if the parameter of the visible light detector is larger than the threshold, activating the infrared light detector by the processing circuit.

15. The detection method of claim 11, further comprising:
maintaining the visible light detector in an active state.

16. The detection method of claim 11, further comprising:
emitting the infrared light by an infrared light source of the detection system, wherein a frequency of emitting the infrared light by the infrared light source comprises once per second.

17. The detection method of claim 11, further comprising:
if the parameter of the visible light detector is not larger than the threshold, determining whether the infrared light detector is activated by the processing circuit; and
if the processing circuit determines that the infrared light detector is activated, deactivating the infrared light detector by the processing circuit.

18. The detection method of claim 11, wherein the parameter comprises an exposure value of the visible light detector, and the threshold comprises an exposure threshold, wherein determining whether the parameter of the visible light detector is larger than the threshold by the processing circuit comprises:
determining whether the exposure value of the visible light detector is larger than the exposure threshold by the processing circuit;
wherein the detection method further comprises:
if the exposure value is not larger than the exposure threshold, executing the human presence detection by the processing circuit according to visible light detected by the visible light detector.

19. The detection method of claim 11, wherein the parameter comprises a detection value of the visible light detector, the detection value relates to an exposure value and a gain value of the visible light detector, and the threshold comprises a detection threshold, wherein determining whether the parameter of the visible light detector is larger than the threshold by the processing circuit comprises:
determining whether the detection value of the visible light detector is larger than the detection threshold by the processing circuit;
wherein the detection method further comprises:
if the detection value is not larger than the detection threshold, executing the human presence detection according to visible light detected by the visible light detector by the processing circuit.

20. The detection method of claim 11, further comprising:
logging in an operating system of a computer system according to the human presence detection result by the processing circuit.
